(19) United States
(12) Patent Application Publication
(10) Pub. No.: US 2019/0154094 A1
(43) Pub. Date: May 23, 2019

(54) FRICTION MATERIAL

(71) Applicant: NISSHINBO BRAKE, INC., TOKYO (JP)

(72) Inventors: TAKAO TANAKA, GUNMA-KEN (JP); TOMOMI IWAI, GUNMA-KEN (JP); MITSUAKI YAGUCHI, GUNMA-KEN (JP)

(73) Assignee: NISSHINBO BRAKE, INC., TOKYO (JP)

(21) Appl. No.: 16/164,743

(22) PCT Filed: Apr. 4, 2017
(86) PCT No.: PCT/JP2017/014028

§ 371 Date: Oct. 18, 2018

(30) Foreign Application Priority Data
Apr. 19, 2016 (JP) 2016-083851

(51) Int. Cl. F16D 69/02

(52) U.S. Cl. CPC F16D 69/026; F16D 2200/006; F16D 2200/0073; F16D 2200/0039

(57) ABSTRACT

[Object] This invention relates to a friction material used for a disc brake pad, which is manufactured by forming a non-asbestos-organic (NAO) friction material composition that contains a binder, a fiber base material, a friction modifier, a lubricant, a pH adjuster, and a filler, which satisfies requirements for the required braking effectiveness, crack resistance, and fade resistance.

[Means to Resolve] The friction material, which is made from the NAO friction material composition, which includes the binder, the fiber base material, the friction modifier, the lubricant, the pH adjuster, and the filler, where the friction modifier contains 5-30 mass % of a later crystal structure titanate, which has the alkali elution rate of 0.1-2.5 mass %, relative to the total amount of the friction material composition. Preferably, in the friction material, the titanate is a magnesium potassium titanate, and as the friction modifier, 5-25 mass % of a monoclinic crystal zirconium oxide relative to the total amount of the friction material composition and 1-5 mass % of a fibrillated organic fiber as the fiber base material relative to the total amount of the friction material composition are contained.

### DETAIL DESCRIPTION OF THE INVENTION

### Technical Field

This invention relates to a friction material used for a disc brake pad such as for an automobile, which is made from a friction material composition.

### Field of the Invention

Conventionally, a disc brake is utilized as a brake device of a passenger car, and a disc brake pad made by fixing the friction material on a metal base member, is utilized as a friction member of the disc brake.

Recently, quietness or stillness in a braking operation is in demand, and a friction material using NAO friction material composition which generates less braking noise has been widely used.

The NAO friction material composition includes a binder, a fiber base material other than steel base fibers such as a steel fiber and a stainless steel fiber, a friction modifier, a lubricant, a pH adjuster, and a filler. Recently, a titanate such as a potassium titanate, a lithium potassium titanate, and a magnesium potassium titanate has widely been used as the friction modifier.

The Patent Document 1 discloses the friction material that does not contain the metal fiber and the copper constituent but contains 10-35 volume % of the potassium titanate having a plurality of protrudent shapes, 3-10 volume % of the abrasive which has Moh's hardness of 7 or more, and 10-30 volume % of an elastomer modified phenolic resin.

The Patent Document 2 discloses the friction material manufactured by forming the non-asbestos friction material composition that contains the binder, the organic filler, the inorganic filler, and the fiber base material, where the copper content in the friction material composition includes the copper element of 0.5 mass % or less relative to the total amount of the friction material composition and the metal fibers other than copper and copper alloy of 0.5 mass % or less relative to the total amount of the friction material composition; the friction material composition includes the titanate and the antimony trisulfide; the titanate is either the lithium potassium titanate or the magnesium potassium titanate; and the content of the titanate is 14-20 mass % relative to the total amount of the friction material composition, and the content of the antimony trisulfide is 2-6 mass % relative to the total amount of the friction material composition.

However, the friction materials in the Patent Document 1 and the Patent Document 2 have problems of insufficiency in satisfying the requirements of such as the braking effectiveness, crack resistance and fade resistance.

The titanate used in the friction material may be the tunnel crystal structure titanate and the layer crystal structure titanate, where the tunnel crystal structure titanate may be such as the potassium hexatitanate, the potassium octatitanate, and the sodium hexatitanate while the layer crystal structure titanate may be such as the lithium potassium titanate and the magnesium potassium titanate.

Then, the titanate is known to have a characteristic of causing the elution of alkali.

The Patent Document 3 discloses the elution of alkali with respect to the titanate as follows.

The alkali elution rate with respect to the titanate compound may be 15 mass % or less, preferably 0.1-15 mass %, more preferably 0.1-10 mass % and further more preferably 0.1-6 mass %. Utilizing the titanate compound inhibits the fading phenomenon and improves the wear resistance. Alkali component generated as the result of wear and tear destruction of the titanate compound seems to have an influence on the generation of the decomposed gas of the organic constituent and the transfer film. Also, the alkali elution rate means the mass rate of the alkali metal and the alkali-earth metal eluted from the titanate compound in the water at 80 centigrade.

In the Patent Document 3, with respect to the numeric value of the alkali elution rate of the titanate, although the layer crystal structure titanate and the tunnel crystal structure titanate are not distinguished, the numeric value of the alkali elution rate is known to be different between the tunnel crystal structure titanate that does not tend to elute alkali and the layer crystal structure titanate that tends to elute alkali.

At present, generally the alkali elution rate of the titanate used in the friction material is such that the tunnel crystal structure titanate is less than 2.0 mass % and the layer crystal structure titanate is 2.6 mass % or more.

The crystal structures and the numeric values of the alkali elution rate of the titanates described in the Patent Document 3 and the Patent Document 4 are shown in a TABLE 1.

TABLE 1
Drawing Number: 000002

| Patent Document | Name of Titanate | Crystal Structure | Alkali Elution Rate |
|---|---|---|---|
| Patent Document 3 | potassium octatitanate | tunnel crystal structure | 0.2 mass % |
| | magnesium potassium titanate | layer crystal structure | 5.3 mass % |
| | potassium hexatitanate | tunnel crystal structure | 0.1 mass % |
| Patent Document 4 | potassium hexatitanate | tunnel crystal structure | 0.1 mass % |
| | potassium octatitanate | tunnel crystal structure | 0.2 mass % |
| | potassium hexatitanate | tunnel crystal structure | 0.2 mass % |
| | magnesium potassium titanate | layer crystal structure | 2.7 mass % |
| | lithium potassium titanate | layer crystal structure | 2.6 mass % |

From the TABLE 1, conventionally, it is understood that the layer crystal structure titanate showing less than 2.6 mass % of the alkali elution rate is not used.

Also, it is known that reducing the alkali elution rate of the titanate reduces the acceleration degradation effect on the organic substance due to the alkaline component when the high temperature and high load braking, thereby reducing the fade resistance. Accordingly, the layer crystal structure titanate with reduced alkali elution rate has not been an option for this purpose.

### PRIOR ARTS

### Patent Documents

### [Patent Document 1] Japanese Provisional Patent Publication No. 2014-122314

### [Patent Document 2] Japanese Provisional Patent Publication No. 2016-824

### [Patent Document 3] Japanese Provisional Patent Publication No. 2014-224175

### [Patent Document 4] Japanese Provisional Patent Publication No. 2014-189612

### SUMMARY OF INVENTION

### Problems to Resolve by the Invention

This invention relates to a friction material used for a disc brake pad, which is made from a non-asbestos (NAO) friction material composition that includes a binder, a fiber base material, a friction modifier, a lubricant, a pH adjuster, and a filler, where the resulted friction material can provide excellent braking effectiveness, crack resistance and fade resistance.

### Means to Resolve the Problems

Inventors of this invention, after serious investigation, found that in the friction material, which is manufactured by forming the NAO friction material composition, used for the disc brake pad and includes the binder, the fiber base material, the friction modifier, the lubricant, the pH adjuster, and the filler, by adjusting the alkali elution rate of the layer crystal structure titanate to be 0.1 mass % or more but 2.5 mass % or less, preferably 0.5 mass % or more but 1.5 mass % or less and adding the predetermined amount of the prepared layer crystal structure titanate in the friction material composition as the friction modifier, the resulted friction material can sufficiently satisfy the required performance with respect to the excellent braking effectiveness, the crack resistance, and the fade resistance, and by including the predetermined amount of the monoclinic crystal zirconium oxide as the friction modifier and the fibrillated organic fiber as the fiber base material to the friction material composition, the resulted friction material can improve the braking effectiveness, the crack resistance, and the fade resistance.

This invention relates to the friction material used for the disc brake pad, which is manufactured by forming the NAO friction material composition that includes the binder, the fiber base material, the friction modifier, the lubricant, the pH adjuster, and the filler and is based on the following technologies.

(1) This invention relates to the friction material used for the disc brake pad, which is made from the NAO friction material composition, which includes the binder, the fiber base material, the friction modifier, the lubricant, the pH adjuster, and the filler, where the friction material composition includes, as the friction modifier, 5-30 mass % of the layer crystal structure titanate with the alkali elution rate of 0.1 mass % or more but 2.5 mass % or less, relative to the total amount of the friction material composition.

(2) This invention relates to the friction material according to the above-(1), where the alkali elution rate of the layer crystal structure titanate is 0.5 mass % or more but 1.5 mass % or less.

(3) This invention relates to the friction material according to the above-(1) or (2), where the layer crystal structure titanate is a magnesium potassium titanate.

(4) This invention relates to the friction material according to any one of the above (1), (2) or (3), where the friction material composition includes 5-25 mass % of the monoclinic crystal zirconium oxide, relative to the total amount of the friction material composition, as the friction modifier, and 1-5 mass % of the fibrillated organic fiber, relative to the total amount of the friction material composition, as the fiber base material.

### Advantage of the Invention

According to this invention, the friction material used for the disc brake pad, which is manufactured by forming the non-asbestos-organic (NAO) friction material composition that contains the binder, the fiber base material, the friction modifier, the lubricant, the pH adjuster, and the filler, which satisfies requirements of the excellent braking effectiveness, crack resistance, and fade resistance.

### EMBODIMENTS OF THE INVENTION

In this invention, the friction material composition is used for the friction material for the disc brake pad, and the friction material is made from the non-asbestos (NAO) friction material composition, which includes the binder, the fiber base material, the friction modifier, the lubricant, the pH adjuster, and the filler, where 5-30 mass % of the layer crystal structure titanate with the alkali elution rate of 0.1 mass % or more but 2.5 mass % or less, relative to the total amount of the friction material composition.

The layer crystal structure titanate tends to form a stable film on a sliding surface of the mating member comparing with the tunnel crystal structure titanate. By adding 5-30 mass % of such layer crystal structure titanate, relative to the total amount of the friction material composition, the braking effectiveness can be improved to satisfy the required performance.

Also, using the layer crystal structure titanate with the alkali elution rate of 0.1 mass % or more but 2.5 mass % or less helps not to hinder an curing reaction of a thermosetting resin as the binder during the heat press forming, and as a result, the mechanical strength of the friction material increases and the crack resistance during the high temperature and high load braking can be improved.

More preferably the layer crystal structure titanate with the alkali elution rate of 0.5 mass % or more but 1.5 mass % or less.

As the layer crystal structure titanate, one type or a combination of two types selected from the magnesium potassium titanate and lithium potassium titanate may be used. In order to improve the fade resistance, the use of magnesium potassium titanate with high heat-resisting property alone is preferred.

Furthermore, by adding 5-25 mass % of the monoclinic crystal zirconium oxide, relative to the total amount of the friction material composition, as the friction modifier, and 1-5 mass % of the fibrillated organic fiber, relative to the total amount of the friction material composition, as the fiber base material, the fade resistance can be improved.

The monoclinic crystal zirconium oxide is characterized to cause volumetric shrinkage at high temperature and to make tetragonal phase transition.

Therefore, during the high temperature and high load braking, the zirconium oxide makes phase transition to shrink the volume, thereby tending to displace the same from the matrix.
The displaced zirconium oxide is supplied onto the friction surface, and by the grinding effect of the zirconium oxide, the frictional destruction of the layer crystal structure titanate progresses and the alkali component is released from the titanate.

Also, by adding the fibrillated organic fiber, the friction material obtains appropriate water absorbency, and atmospheric moisture tends to be absorbed inside the friction material.

The atmospheric moisture absorbed inside the friction material tends to release the alkali component of the layer crystal structure titanate.

When the layer crystal structure titanate with relatively lower alkali elution rate is used, a multiplier effect of the above-described effect, during the high temperature and high load braking, allows to supply sufficient alkali component onto the friction surface, thereby promoting the decomposition of the organic substance. As a result, the fade resistance is improved.

Using the monoclinic crystal zirconium oxide with the average particle diameter of 1.0-3.0 μm improves the frictional resistance and reduces the aggressiveness against the mating surface.

Also, the average particle diameter, measured by the laser diffraction size analyzing method, is 50% particle diameter.

As the fibrillated organic fiber, one type or any combination of two or more types of fibers selected from the aramid fiber, the cellulose fiber, and the polyacrylonitrile fiber can be used. In order to improve the crack resistance, it is preferable to use the aramid fiber alone which has a higher reinforcing effect.

The friction material of this invention includes the binder, the fiber base material, the friction modifier, the lubricant, the pH adjuster, and the filler that are generally used for the friction material in addition to the above-described layer crystal structure titanate, the monoclinic crystal zirconium oxide and the fibrillated organic fiber.

The binder may be binders that are generally used for the friction material such as a straight phenolic resin, the resin as a result of modifying the phenolic resin by a cashew oil, various elastomers such as an acryl rubber and a silicone rubber, an aralkyl modified phenolic resin obtained by reacting the phenol compound, aralkyl ethyl compound and an aldehyde compound, and a thermosetting resin obtained by dispersing such as various elastomers or fluoropolymer in the phenolic resin, one type or any combination of two or more types may be used.

The amount of the binder, for the purpose of securing the mechanical strength and wear resistance, is preferably 7-15 mass % relative to the total amount of the friction material composition but more preferably 8-12 mass % relative to the total amount of the friction material composition.

The fiber base material, in addition to the above-described fibrillated organic fiber, may be metal fibers such as a copper fiber, a bronze fiber, a brass fiber, an aluminum fiber and an aluminum alloy fiber, and one type or any combination of two or more types may be used.

When the metal fiber is used, the content of the fiber base material together with the above-described fibrillated organic fiber is 2-20 mass % relative to the total amount of the friction material composition but more preferably 3-15 mass % relative to the total amount of the friction material composition.

The inorganic friction modifier, in addition to the above-described layer crystal structure titanate and the monoclinic crystal zirconium oxide, may be a particle inorganic modifier such as the stabilized zirconium oxide, a zirconium silicate, a magnesium oxide, an α-alumina, a γ-alumina, a talc, a mica, a vermiculite, a zinc particle, a copper particle, a brass particle, an aluminum particle, an aluminum alloy particle, and a tunnel crystal structure titanate and a fiber inorganic friction modifier such as a wollastonite, a sepiolite, a basalt fiber, a grass fiber, a biosoluble ceramic fiber, and a rock wool. In this invention, one type or any combination of two or more types of the above-inorganic friction modifier may be used.

The amount of the inorganic friction modifier together with the above-described layer crystal structure titanate and the monoclinic crystal zirconium oxide is preferably 30-70 mass % relative to the total amount of the friction material composition but more preferably 40-60 mass % relative to the total amount of the friction material composition.

The organic friction modifier may be a cashew dust, a pulverized powder of a tire tread rubber, or a vulcanized rubber powder or an unvulcanized rubber powder of a nitrile rubber, an acrylic rubber, a butyl rubber, a silicone rubber and so on. In this invention, one type or any combination of two or more types of the above-organic friction modifier may be used.

The amount of the organic friction modifier contained in the friction material composition is preferably 3-8 mass % relative to the total amount of the friction material composition but more preferably 4-7 mass % relative to the total amount of the friction material composition.

The lubricant may be such as metal sulfide type lubricants such as a zinc sulfide, a molybdenum disulfide, a tin sulfide, an iron sulfide, and a composite metal sulfide and carbon type lubricants such as a synthetic graphite, a natural graphite, an exfoliated graphite, a petroleum coke, a resilient graphitic carbon, and a polyacrylonitrile oxidized fiber pulverized powder, which are normally used in the friction material. In this invention, one type or any combination of two or more types of the above-lubricants may be used.

The amount of lubricant is preferably 3-8 mass % relative to the total amount of the friction material composition but more preferably 4-6 mass % relative to the total amount of the friction material composition.

The pH adjuster, such as a calcium hydroxide, which normally used for the friction material may be used.

The amount of pH adjuster is preferably 2-6 mass % relative to the total amount of the friction material composition but more preferably 2-3 mass % relative to the total amount of the friction material composition.

The filler may be such as a barium sulfate and a calcium carbonate.

Also, with respect to the copper component contained in the friction material, California State (CA) and Washington State (WA) of the United States of America passed a bill to prohibit the sales of the friction member using the friction material containing 5.0 mass % or more of the copper component relative to the total amount of the friction material composition and an act of assembling the subject friction member in a new car from the year of 2021, and to prohibit the sales of the friction member using the friction material containing 0.5 mass % or more of the copper component relative to the total amount of the friction material composition and an act of assembling the subject friction member in a new car from the year of 2025. Accordingly, preferably, the copper component such as the fiber and particles containing copper is added to the friction material composition so as to conform to the regulations but more preferably the copper component is not added to the friction material composition.

The friction material of this invention is manufactured through a mixing step for mixing the predetermined amount of the friction material composition uniformly using a mixer so as to obtain a raw friction material mixture, a heat press forming step for heat press forming the raw friction material mixture superposed on a back plate which is pre-washed, surface-treated, and adhesive coated to obtain a molded article, a heat treatment step for completing the curing effect of the binder by heating the molded article to obtain heated article, a coating step for coating the heated article with such as splay coating and electrostatic powder coating to obtain coated article, a coating baking step for baking the coating on the coated article to obtain a backed article, and grinding step for grinding the backed article by the rotating grinding stone.

Yet, after the heat press forming step, the coating step, the heat treatment step doubling the coating baking step and the grinding step may be allowed.

As necessary, prior to the heat press forming step, a granulating step for granulating the raw friction material mixture, a kneading step for kneading the raw friction material mixture, and a preforming step for forming an intermediate preformed product by molding the raw friction material mixture, the granulated friction material composition obtained through the granulating step or the kneaded friction material composition obtained through the kneading step in the preforming die, may be performed, and a scorch step may be performed after the heat press forming step.

### Embodiments

In the following sections, the embodiments and the comparative examples are shown to give more specific explanations of this invention; however, this invention is not limited to what is described in the following embodiments and comparative examples.

### Manufacturing Method for the Friction Material Embodiments 1-19 and Comparative Examples 1-4

The friction material composition shown in TABLE 2, TABLE 3, and TABLE 4 is mixed for 5 minutes with the Loedige mixer and is pressed in the forming die for 10 seconds under 30 MPa for form the intermediate preformed product. This intermediate preformed product is superposed on the steel back plate that is pre-washed, pre-surface treated, and pre-adhesive coated, formed in the heat forming die at 150 degrees centigrade of the forming temperature under 40 MPa of the forming pressure for 10 minutes. After that, heat-treated (cured) at 200 degrees centigrade for 5 hours, and grinded to form the friction surface in order to manufacture the disc brake pad for a passenger car. (See Embodiments 1-19 and Comparative Examples 1-4)

TABLE 2

| | | Embodiments | | | | | | | | | |
|---|---|---|---|---|---|---|---|---|---|---|---|
| | | 1 | 2 | 3 | 4 | 5 | 6 | 7 | 8 | 9 | 10 |
| Binder | straight phenolic | 8.0 | 8.0 | 8.0 | 8.0 | 8.0 | 8.0 | 8.0 | 8.0 | 8.0 | 8.0 |
| | resin | | | | | | | | | | |
| Fiber | fibrillated aramid | 3.0 | 3.0 | 3.0 | 3.0 | 3.0 | 3.0 | 3.0 | 3.0 | 3.0 | |
| Base | fiber | | | | | | | | | | |
| Material | fibrillated | | | | | | | | | | 3.0 |
| | cellulose fiber | | | | | | | | | | |
| | fibrillated | | | | | | | | | | |
| | polyacrylonitrile | | | | | | | | | | |
| | fiber | | | | | | | | | | |
| Lubricant | molybdenum | 1.0 | 1.0 | 1.0 | 1.0 | 1.0 | 1.0 | 1.0 | 1.0 | 1.0 | 1.0 |
| | disulfide | | | | | | | | | | |
| | graphite | 3.0 | 3.0 | 3.0 | 3.0 | 3.0 | 3.0 | 3.0 | 3.0 | 3.0 | 3.0 |
| Inorganic | magnesium | | | | | | | | | | |
| Friction | potassium | | | | | | | | | | |
| Modifier | titanate (alkali | | | | | | | | | | |
| | elution rate = | | | | | | | | | | |
| | 3.0%) | | | | | | | | | | |
| | magnesium | 20.0 | | | | | | | | | |
| | potassium | | | | | | | | | | |
| | titanate (alkali | | | | | | | | | | |
| | elution rate = | | | | | | | | | | |
| | 2.5%) | | | | | | | | | | |
| | magnesium | | 20.0 | | | | | | | | |
| | potassium | | | | | | | | | | |
| | titanate (alkali | | | | | | | | | | |
| | elution rate = | | | | | | | | | | |
| | 1.5%) | | | | | | | | | | |
| | magnesium | | | 20.0 | | | | 10.0 | 5.0 | 30.0 | 20.0 |
| | potassium | | | | | | | | | | |
| | titanate (alkali | | | | | | | | | | |
| | elution rate = | | | | | | | | | | |
| | 1.0%) | | | | | | | | | | |
| | magnesium | | | | 20.0 | | | | | | |
| | potassium | | | | | | | | | | |
| | titanate (alkali | | | | | | | | | | |
| | elution rate = | | | | | | | | | | |
| | 0.5%) | | | | | | | | | | |
| | magnesium | | | | | 20.0 | | | | | |
| | potassium | | | | | | | | | | |
| | titanate (alkali | | | | | | | | | | |
| | elution rate = | | | | | | | | | | |
| | 0.1%) | | | | | | | | | | |
| | magnesium | | | | | | | | | | |
| | potassium | | | | | | | | | | |
| | titanate (alkali | | | | | | | | | | |
| | elution rate = | | | | | | | | | | |
| | 0.05%) | | | | | | | | | | |
| | lithium | | | | | | 20.0 | 10.0 | | | |
| | potassium | | | | | | | | | | |
| | titanate (alkali | | | | | | | | | | |
| | elution rate = | | | | | | | | | | |
| | 1.0%) | | | | | | | | | | |
| | monoclinic | 20.0 | 20.0 | 20.0 | 20.0 | 20.0 | 20.0 | 20.0 | 20.0 | 20.0 | 20.0 |
| | crystal zirconium | | | | | | | | | | |
| | oxide (average | | | | | | | | | | |
| | particle diameter = | | | | | | | | | | |
| | 2.0 μm) | | | | | | | | | | |
| | zirconium silicate | 3.0 | 3.0 | 3.0 | 3.0 | 3.0 | 3.0 | 3.0 | 3.0 | 3.0 | 3.0 |
| | mica | 5.0 | 5.0 | 5.0 | 5.0 | 5.0 | 5.0 | 5.0 | 5.0 | 5.0 | 5.0 |
| Organic | cashew dust | 5.0 | 5.0 | 5.0 | 5.0 | 5.0 | 5.0 | 5.0 | 5.0 | 5.0 | 5.0 |
| Friction | pulverized | 2.0 | 2.0 | 2.0 | 2.0 | 2.0 | 2.0 | 2.0 | 2.0 | 2.0 | 2.0 |
| Modifier | powder of tire | | | | | | | | | | |
| | tread rubber | | | | | | | | | | |
| pH | calcium | 3.0 | 3.0 | 3.0 | 3.0 | 3.0 | 3.0 | 3.0 | 3.0 | 3.0 | 3.0 |
| Adjuster | hydroxide | | | | | | | | | | |
| Filler | barium sulfate | 27.0 | 27.0 | 27.0 | 27.0 | 27.0 | 27.0 | 27.0 | 42.0 | 17.0 | 27.0 |

| | | | | | | | | | | |
|---|---|---|---|---|---|---|---|---|---|---|
| Total | 100.0 | 100.0 | 100.0 | 100.0 | 100.0 | 100.0 | 100.0 | 100.0 | 100.0 | 100.0 |

TABLE 3

| | | Embodiments | | | | | | | | |
|---|---|---|---|---|---|---|---|---|---|---|
| | | 11 | 12 | 13 | 14 | 15 | 16 | 17 | 18 | 19 |
| Binder | straight | 8.0 | 8.0 | 8.0 | 8.0 | 8.0 | 8.0 | 8.0 | 8.0 | 8.0 |
| | phenolic resin | | | | | | | | | |
| Fiber | fibrillated | 1.5 | 1.0 | 2.0 | 4.0 | 5.0 | 3.0 | 3.0 | 3.0 | 3.0 |
| Base | aramid fiber | | | | | | | | | |
| Material | fibrillated | | | | | | | | | |
| | cellulose fiber | | | | | | | | | |
| | fibrillated | 1.5 | | | | | | | | |
| | polyacrylonitrile | | | | | | | | | |
| | fiber | | | | | | | | | |
| Lubricant | molybdenum | 1.0 | 1.0 | 1.0 | 1.0 | 1.0 | 1.0 | 1.0 | 1.0 | 1.0 |
| | disulfide | | | | | | | | | |
| | graphite | 3.0 | 3.0 | 3.0 | 3.0 | 3.0 | 3.0 | 3.0 | 3.0 | 3.0 |
| Inorganic | magnesium | | | | | | | | | |
| Friction | potassium | | | | | | | | | |
| Modifier | titanate (alkali | | | | | | | | | |
| | elution rate = | | | | | | | | | |
| | 3.0%) | | | | | | | | | |
| | magnesium | | | | | | | | | |
| | potassium | | | | | | | | | |
| | titanate (alkali | | | | | | | | | |
| | elution rate = | | | | | | | | | |
| | 2.5%) | | | | | | | | | |
| | magnesium | | | | | | | | | |
| | potassium | | | | | | | | | |
| | titanate (alkali | | | | | | | | | |
| | elution rate = | | | | | | | | | |
| | 1.5%) | | | | | | | | | |
| | magnesium | 20.0 | 20.0 | 20.0 | 20.0 | 20.0 | 20.0 | 20.0 | 20.0 | 20.0 |
| | potassium | | | | | | | | | |
| | titanate (alkali | | | | | | | | | |
| | elution rate = | | | | | | | | | |
| | 1.0%) | | | | | | | | | |
| | magnesium | | | | | | | | | |
| | potassium | | | | | | | | | |
| | titanate (alkali | | | | | | | | | |
| | elution rate = | | | | | | | | | |
| | 0.5%) | | | | | | | | | |
| | magnesium | | | | | | | | | |
| | potassium | | | | | | | | | |
| | titanate (alkali | | | | | | | | | |
| | elution rate = | | | | | | | | | |
| | 0.1%) | | | | | | | | | |
| | magnesium | | | | | | | | | |
| | potassium | | | | | | | | | |
| | titanate (alkali | | | | | | | | | |
| | elution rate = | | | | | | | | | |
| | 0.05%) | | | | | | | | | |
| | lithium | | | | | | | | | |
| | potassium | | | | | | | | | |
| | titanate (alkali | | | | | | | | | |
| | elution rate = | | | | | | | | | |
| | 1.0%) | | | | | | | | | |
| | monoclinic | 20.0 | 20.0 | 20.0 | 20.0 | 20.0 | 4.0 | 5.0 | 25.0 | 26.0 |
| | crystal | | | | | | | | | |
| | zirconium oxide | | | | | | | | | |
| | (average | | | | | | | | | |
| | particle | | | | | | | | | |
| | diameter = | | | | | | | | | |
| | 2.0 μm) | | | | | | | | | |
| | zirconium | 3.0 | 3.0 | 3.0 | 3.0 | 3.0 | 3.0 | 3.0 | 3.0 | 3.0 |
| | silicate | | | | | | | | | |
| | mica | 5.0 | 5.0 | 5.0 | 5.0 | 5.0 | 5.0 | 5.0 | 5.0 | 5.0 |
| Organic | cashew dust | 5.0 | 5.0 | 5.0 | 5.0 | 5.0 | 5.0 | 5.0 | 5.0 | 5.0 |
| Friction | pulverized | 2.0 | 2.0 | 2.0 | 2.0 | 2.0 | 2.0 | 2.0 | 2.0 | 2.0 |
| Modifier | powder of tire | | | | | | | | | |
| | tread rubber | | | | | | | | | |
| pH | calcium | 3.0 | 3.0 | 3.0 | 3.0 | 3.0 | 3.0 | 3.0 | 3.0 | 3.0 |
| Adjuster | hydroxide | | | | | | | | | |
| Filler | barium sulfate | 27.0 | 29.0 | 28.0 | 26.0 | 25.0 | 43.0 | 42.0 | 22.0 | 21.0 |

| | | | | | | | | | |
|---|---|---|---|---|---|---|---|---|---|
| Total | 100.0 | 100.0 | 100.0 | 100.0 | 100.0 | 100.0 | 100.0 | 100.0 | 100.0 |

TABLE 4

| | | Comparative Examples | | | |
|---|---|---|---|---|---|
| | | 1 | 2 | 3 | 4 |
| Binder | straight phenolic resin | 8.0 | 8.0 | 8.0 | 8.0 |
| Fiber Base | fibrillated aramid fiber | 3.0 | 3.0 | 3.0 | 3.0 |
| Material | fibrillated cellulose fiber | | | | |
| | fibrillated polyacrylonitrile | | | | |
| | fiber | | | | |
| Lubricant | molybdenum disulfide | 1.0 | 1.0 | 1.0 | 1.0 |
| | graphite | 3.0 | 3.0 | 3.0 | 3.0 |
| Inorganic | magnesium potassium titanate | 20.0 | | | |
| Friction | (alkali elution rate = 3.0%) | | | | |
| Modifier | magnesium potassium titanate | | | | |
| | (alkali elution rate = 2.5%) | | | | |
| | magnesium potassium titanate | | | | |
| | (alkali elution rate = 1.5%) | | | | |
| | magnesium potassium titanate | | | 4.0 | 31.0 |
| | (alkali elution rate = 1.0%) | | | | |
| | magnesium potassium titanate | | | | |
| | (alkali elution rate = 0.5%) | | | | |
| | magnesium potassium titanate | | | | |
| | (alkali elution rate = 0.1%) | | | | |
| | magnesium potassium titanate | | 20.0 | | |
| | (alkali elution rate = 0.05%) | | | | |
| | lithium potassium titanate | | | | |
| | (alkali elution rate = 1.0%) | | | | |
| | monoclinic crystal zirconium | 20.0 | 20.0 | 20.0 | 20.0 |
| | oxide (average particle | | | | |
| | diameter = 2.0 μm) | | | | |
| | zirconium silicate | 3.0 | 3.0 | 3.0 | 3.0 |
| | mica | 5.0 | 5.0 | 5.0 | 5.0 |
| Organic | cashew dust | 5.0 | 5.0 | 5.0 | 5.0 |
| Friction | pulverized powder of tire | 2.0 | 2.0 | 2.0 | 2.0 |
| Modifier | tread rubber | | | | |
| pH Adjuster | calcium hydroxide | 3.0 | 3.0 | 3.0 | 3.0 |
| Filler | barium sulfate | 27.0 | 27.0 | 43.0 | 16.0 |

| | | | | |
|---|---|---|---|---|
| Total | 100.0 | 100.0 | 100.0 | 100.0 |

The braking effectiveness, the crack resistance, and the fade resistance of these disc brake pads are evaluation based on the conditions shown in TABLE 5. The evaluation standard is shown in TABLE 5, and the evaluation results are shown in TABLE 6, TABLE 7, and TABLE 8.

TABLE 5

| | Braking | | Fade | |
|---|---|---|---|---|
| | Effectiveness | Crack Resistance | Resistance | Brake Noise |
| | Based on | Based on JASO C427 | Based on | Based on |
| | JASO C406 | Wear test on | JASO C406 | JASO C404 |
| | 2nd Effectiveness | individual temperature | 1st Fade Test | Brake noise |
| | Test Average | Pre-braking | Minimum | occurrence |
| | friction | temperature: 400 | friction | rate |
| | coefficient | degrees centigrade | coefficient | |
| | | Repeat braking until | | |
| | | thickness of the | | |
| | | friction material | | |
| | | becomes half | | |
| Excellent (EX) | 0.45 or more | No visible crack and | 0.32 or more | less than 1.0% |
| | | fissure on the friction | | |
| | | material surface after | | |
| | | testing | | |
| Good (GD) | 0.42 or more | Slight cracking on the | 0.30 or more | 1.0% or more |
| | but less than 0.45 | friction material | but less than 0.32 | but less than 1.5% |
| | | surface after testing | | |
| | | (Unable to insert | | |
| | | 0.1 mm thickness | | |
| | | gage) | | |
| Average (AV) | 0.39 or more | Small cracking on the | 0.28 or more | 1.5% or more |
| | but less than 0.42 | friction material | but less than 0.30 | but less than 2.0% |
| | | surface after testing | | |
| | | (Able to insert 0.1 mm | | |
| | | thickness gage but | | |
| | | unable to insert | | |
| | | 0.5 mm thickness | | |
| | | gage) | | |
| Bad (BD) | less than 0.39 | Large cracking on the | less than 0.28 | 2.0% or more |
| | | friction material | | |
| | | surface after testing | | |
| | | (Able to insert 0.5 mm | | |
| | | thickness gage) | | |

TABLE 6

| | | Embodiments | | | | | | | | | |
|---|---|---|---|---|---|---|---|---|---|---|---|
| | | 1 | 2 | 3 | 4 | 5 | 6 | 7 | 8 | 9 | 10 |
| Evaluation | Braking | GD | EX | EX | EX | EX | GD | EX | AV | AV | EX |
| Result | Effectiveness | | | | | | | | | | |
| | Crack | GD | EX | EX | EX | EX | EX | EX | EX | GD | AV |
| | Resistance | | | | | | | | | | |
| | Fade | GD | EX | EX | EX | GD | GD | GD | AV | AV | EX |
| | Resistance | | | | | | | | | | |
| | Brake Noise | EX | EX | EX | EX | EX | EX | EX | EX | EX | EX |
| | Mixture | No | No | No | No | No | No | No | No | No | No |
| | Condition | | | | | | | | | | |
| | (Fiber Ball | | | | | | | | | | |
| | Existence) | | | | | | | | | | |

EX = Excellent,
GD = Good,
AV = Average

TABLE 7

| | | Embodiments | | | | | | | | |
|---|---|---|---|---|---|---|---|---|---|---|
| | | 11 | 12 | 13 | 14 | 15 | 16 | 17 | 18 | 19 |
| Evaluation | Braking | EX | EX | EX | EX | EX | EX | EX | EX | EX |
| Result | Effectiveness | | | | | | | | | |
| | Crack | GD | EX | EX | EX | EX | EX | EX | EX | EX |
| | Resistance | | | | | | | | | |
| | Fade | EX | AV | GD | EX | EX | AV | GD | EX | EX |
| | Resistance | | | | | | | | | |
| | Brake Noise | EX | EX | EX | EX | EX | EX | EX | GD | AV |
| | Mixture | No | No | No | No | Exist | No | No | No | No |
| | Condition | | | | | | | | | |
| | (Fiber Ball | | | | | | | | | |
| | Existence) | | | | | | | | | |

TABLE 8

| | | Comparative Examples | | | |
|---|---|---|---|---|---|
| | | 1 | 2 | 3 | 4 |
| Evaluation | Braking Effectiveness | BD | GD | BD | BD |
| Result | Crack Resistance | GD | EX | EX | GD |
| | Fade Resistance | BD | BD | BD | AV |
| | Brake Noise | EX | EX | EX | EX |
| | Mixture Condition | No | No | No | No |
| | (Fiber Ball Existence) | | | | |

From the respective TABLES, the friction materials satisfying the conditions described in this invention show excellent braking effectiveness, crack resistance, and fade resistance.

### INDUSTRIAL APPLICABILITY

According to this invention, the friction material for the disc brake pad, which is manufactured by forming NAO friction material composition, can satisfy the legal requirement with respect to the minimum amount of the copper component and can satisfy the required performance with respect to the braking effectiveness, the crack resistance, and the fade resistance, thereby offering highly practical and valuable product.

1. A friction material used for a disc brake pad, which is manufactured by forming a non-asbestos-organic (NAO) friction material composition that contains a binder, a fiber base material, a friction modifier, a lubricant, a pH adjuster, and a filler, wherein
said friction material composition contains, as the friction modifier, 5-30 mass % of a layer crystal structure titanate, which has 0.1 or more mass % but 2.5 or less mass % of alkali elution rate, relative to the total amount of the friction material composition.

2. The friction material according to claim 1, wherein
alkali elution rate of said layer crystal structure titanate is 0.5 mass % or more but 1.5 mass % or less.

3. The friction material according to claim 1, wherein
said layer crystal structure titanate is a magnesium potassium titanate.

4. The friction material according to claim 1, wherein
said friction material composition contains 5-25 mass % of a monoclinic crystal zirconium oxide relative to the total amount of the friction material composition, as the friction modifier and 1-5 mass % of a fibrillated organic fiber relative to the total amount of the friction material composition, as the fiber base material.

5. The friction material according to claim 2, wherein
said layer crystal structure titanate is a magnesium potassium titanate.

6. The friction material according to claim 2, wherein
said friction material composition contains 5-25 mass % of a monoclinic crystal zirconium oxide relative to the total amount of the friction material composition, as the friction modifier and 1-5 mass % of a fibrillated organic fiber relative to the total amount of the friction material composition, as the fiber base material.

7. The friction material according to claim 3, wherein
said friction material composition contains 5-25 mass % of a monoclinic crystal zirconium oxide relative to the total amount of the friction material composition, as the friction modifier and 1-5 mass % of a fibrillated organic fiber relative to the total amount of the friction material composition, as the fiber base material.

8. The friction material according to claim 5, wherein
said friction material composition contains 5-25 mass % of a monoclinic crystal zirconium oxide relative to the total amount of the friction material composition, as the friction modifier and 1-5 mass % of a fibrillated organic fiber relative to the total amount of the friction material composition, as the fiber base material.
